(19) United States
(12) Patent Application Publication
(10) Pub. No.: US 2004/0002376 A1
(43) Pub. Date: Jan. 1, 2004

(54) Gaming device having an incrementing award bonus scheme

(76) Inventors: Brian D. Swift, Sparks, NV (US); Anthony J. Baerlocher, Reno, NV (US)

Correspondence Address: BELL, BOYD & LLOYD LLC, P. O. BOX 1135, CHICAGO, IL, 60690-1135, US

(21) Appl. No.: 10/185,415

(22) Filed: Jun. 27, 2002

(51) Int. Cl. A63F 13/00

(52) U.S. Cl. 463/25; 463/22

(57) ABSTRACT

A gaming device and method having a bonus game, where the gaming device enables a player to select symbol indicators such as a pair of dice from one or more pairs of dice. The gaming device rolls the selected pair of dice and the player receives a random number that is based on the sum of the numbers on each die in the selected pair of dice. If the number is not a terminator or doubles, an award is provided to the player. Subsequently, an award accelerator increases the award for the next roll by a random or predefined amount. If the number is a terminator, the game ends and the player receives the total accumulated award in the game. If the number is doubles, the player receives a larger award generated by the award accelerator. The accelerator doubles the award for a roll that results in doubles and increases subsequent awards from this award value. The player continues to select pairs of dice until the player receives a terminator or until they have no rolls remaining in the game.

### CROSS REFERENCE TO RELATED APPLICATIONS

This application is related to the following commonly-owned copending patent applications: “GAMING DEVICE HAVING MULTIPLE AWARD ENHANCING LEVELS,” Ser. No. 09/967,016, Attorney Docket No. 0112300-882; “GAMING DEVICE HAVING MULTIPLE AWARD ENHANCING LEVELS,” Ser. No. 09/966,956, Attorney Docket No. 0112300-883; and “GAMING DEVICE HAVING A BONUS ROUND WITH MULTIPLE RANDOM AWARD GENERATION AND MULTIPLE RETURN/RISK SCENARIOS,” Ser. No. 09/678,989, Attorney Docket No. 0112300-020.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

The present invention relates to a gaming device having an incrementing award game.

Gaming device manufacturers constantly strive to make gaming devices that provide as much enjoyment and excitement as possible. Providing a secondary or bonus game in which a player has an opportunity to win potentially large awards or credits in addition to the awards associated with the primary or base game of the gaming device is one known method for enhancing player enjoyment and excitement.

Gaming devices having bonus games generally employ a triggering event that occurs during the operation of the base game of the gaming device. The triggering event temporarily stalls or halts the base game play and enables a player to enter a second, different game, which is the secondary or bonus game. The player plays the bonus game, likely receives an award, and returns to the base game.

Gaming devices exist with bonus games having a goal or objective of rolling one or more dies to achieve the highest award possible. One example is a bonus game that employs the traditional dice game of Craps. Generally, Craps is a game where a player rolls dice to obtain specific number combinations or numbers on the dice. When employed as a bonus game in a gaming machine, the dice are rolled by the gaming machine. Such gaming machines have physical representations of dice or utilize a video display that simulates the roll of the dice.

In other gaming devices, dice have been used to simulate a poker hand. This type of game is played by rolling five dice. The dice are physically represented or simulated on a video display. A player starts that game with a particular number of rolls. After the player rolls the dice for the first time, a poker hand is created from the numbers indicated by each of the five dice. The player tries to obtain one of several different poker combinations such as five of a kind, a full house or a straight. More difficult combinations return higher awards than less difficult to obtain combinations. The gaming device enables a player to keep certain dies or numbers from their first roll and then re-roll the rest of the dice. In this manner, the player can strive to obtain the best poker combination possible. The player may continue to hold and/or roll the dice until they are out of rolls or until they are satisfied with a particular combination.

Thus, while there are certain known uses of dice in bonus games, there is constantly a need for new and different primary games and secondary games for gaming devices which employ dice and other types of indicating devices and which provide enjoyment and entertainment to players. It is also desirable to provide new primary and secondary games for gaming machines which vary award returns and risk to increase player excitement and enjoyment. For example, players enjoy playing gaming devices having secondary or bonus games which present a risk of termination that is commensurate with the likelihood of obtaining a larger award. However, in many of these types of games, a player is more likely to obtain a terminator or lessor award before obtaining one of the larger awards. Therefore, it is desirable to provide a secondary or bonus game of a gaming device that provides greater opportunities for players to obtain large awards without such an increased risk of termination.

### SUMMARY OF THE INVENTION

The present invention is directed to a gaming device having a symbol indicator in a primary game or secondary game. In one embodiment primarily discussed herein, the gaming device of the present invention provides a secondary or bonus game including one or more sets or groups of symbol indicators having at least two symbol indicators in the form of a pair of dice and in one preferred embodiment, preferably two pair of dice. In one embodiment, each die is a mechanical six-sided die which includes the integers one through six or symbols (such as dots) representing the integers one through six. The game provides the player with a predetermined or random number of activations or rolls of the pairs of dice when the bonus game begins. The player starts the bonus game by selecting one of the pairs of dice. In this embodiment, the selected dice are activated or rolled (or alternatively both pairs of dice are activated or rolled) to randomly generate a number. In one embodiment, the number is based on or is the sum of each individual number generated by each die in the pair. The number generated by the dice determines whether the player receives an award and the amount of the award. In another embodiment, the gaming device provides a single pair of dice and repeatedly activates that pair of dice until there are no activations remaining.

In one embodiment, a terminator, terminator symbol or terminating number is included on the symbol indicators. If the number is a number other than a terminator or terminating number (discussed below), the player receives an award associated with the successful completion of that roll of the dice. The awards start at a predetermined level at the beginning of each play of the bonus game and increase incrementally after each subsequent roll of the dice. In one embodiment, if the player receives doubles, which means that the number (or symbol) on each die in the selected pair of die is the same or related, then the award level for that roll doubles as well. At that point, the awards for subsequent rolls that do not result in a terminator or terminating number, increase incrementally from the doubled award level. The player continues to roll the dice until they obtain a terminator or if there are a limited number of rolls, until no rolls are remaining in the game. Each subsequent roll that results in doubles, doubles the award for that roll. It should be appreciated that each roll that results in doubles, may double the total or accumulated award in a game, or any other suitable award in a game provided to a player.

In one embodiment, each selection by a player that does not generate a terminator or terminating number, results in an award to the player. The award is in one embodiment, a predetermined value. However, it is contemplated that in alternative embodiments, for example, the player's award may be based on the actual sum of the numbers on each die of the selected pair of dice, or the processor or controller of the gaming device could randomly determine the award provided to the player.

If the number is a terminator or terminating number, the game ends and the player receives the total value of the awards that the player accumulated to that point. In one embodiment, the terminator or terminating number is a specific number such as the number seven. In another embodiment, the terminator is established in a particular roll or rolls. For example in a game, a player may roll the pair of dice and the dice indicate a one and a three. This establishes the terminator in the game. In each roll after that roll, if the player rolls the one and three again, the game ends because the one and three is the terminator. In a further embodiment, the numbers indicated on the dice in a particular roll become the terminator as well as all combinations of numbers that equal the sum of the numbers in that roll. For example, if the player rolls a one and a three, which becomes the terminator, then the one and three combination and the two and two combination are terminators in the game. It should be appreciated that any number or combination of numbers may be the terminator or terminating number as desired by an implementor. Also, it should be appreciated that there may be more than one terminator or terminating number in the bonus game.

In one embodiment, each die includes integers from one through six. It should be appreciated that in other embodiments, the dice may include symbols, letters or other numbers. If the dice includes symbols or letters, the awards may be associated with predetermined symbol or letter combinations as desired by an implementor. It should also be appreciated that other symbol generators (besides dice) may be employed in the present invention.

In one embodiment of the present invention, the gaming device displays one pair of dice to the player and repeatedly activates or rolls that pair of dice until a terminator is obtained or until no rolls are remaining in the game. In another embodiment, the player selects a pair of dice, and continues to roll that pair of dice until a terminator or terminating number is obtained or until there are no rolls remaining in the game. In a further embodiment of the present invention, the player selects a different pair of dice after each roll until the player obtains a terminator or terminating number or until the player has no rolls remaining in the game. This adds an additional level of player input and enjoyment to the game of the present invention.

In another embodiment, a probability of being indicated is associated with each symbol or number combination on the pair of indicators such that the probability associated with one combination is greater than the probability associated with another combination. In a further embodiment, the probabilities associated with the number combinations equal the actual probability of the numbers being indicated on the dice after the dice are rolled.

Although the present invention is primarily discussed relative to a bonus game of a gaming machine, it should be appreciated that the present invention could be employed as a primary game in a gaming device. In such case, the primary game may include a plurality of terminators or terminating numbers or different probability more suitable for primary game implementation.

It is therefore an advantage of the present invention to provide a gaming device having an incrementing award bonus game that provides larger awards to players.

Another advantage of the present invention to provide larger awards to players that increase player excitement and entertainment.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1A is a front perspective view of one embodiment of the gaming device of the present invention.

FIG. 1B is a front perspective of another embodiment of the gaming device of the present invention.

FIG. 2 is a schematic block diagram of the electronic configuration of one embodiment of the gaming device of the present invention.

FIG. 3 is a flow diagram of one embodiment of the present invention where a player may pick different indicators with each selection in one game.

FIG. 4 is a flow diagram of another embodiment of the present invention where a player maintains the same indicators throughout the game.

FIG. 5 is an enlarged front elevation view of one of the display devices of FIGS. 1A and 1B illustrating one embodiment of the present invention.

FIG. 6A is an enlarged front elevation view of one of the display devices of FIGS. 1A and 1B illustrating a first pick by a player in one embodiment of a game of the present invention.

FIG. 6B is an enlarged front elevation view of one of the display devices of FIGS. 1A and 1 B illustrating a second pick by a player in one embodiment of a game of the present invention.

FIG. 6C is an enlarged front elevation view of one of the display devices of FIGS. 1A and 1B illustrating the incrementing of the award prior to the third pick by a player.

FIG. 6D is an enlarged front elevation view of one of the display devices of FIGS. 1A and 1B illustrating a third pick by a player in one embodiment of a game of the present invention where the player obtained doubles.

FIG. 6E is an enlarged front elevation view of one of the display devices of FIGS. 1A and 1 B illustrating a fourth pick by a player in one embodiment of a game of the present invention.

FIG. 7A is an enlarged front elevation view of one of the display devices of FIGS. 1A and 1B illustrating another embodiment of the present invention where a player picks indicators and maintains those indicators throughout the game.

FIG. 7B is an enlarged front elevation view of one of the display devices of FIGS. 1A and 1B illustrating a first pick by a player in one embodiment of a game of the present invention.

FIG. 7C is an enlarged front elevation view of one of the display devices of FIGS. 1A and 1B illustrating the incrementing of the award prior to the second pick by the player.

FIG. 7D is an enlarged front elevation view of one of the display devices of FIGS. 1A and 1B illustrating a second pick by a player in one embodiment of a game of the present invention.

FIG. 7E is an enlarged front elevation view of one of the display devices of FIGS. 1A and 1B illustrating a third pick by a player in one embodiment of a game of the present invention.

FIG. 7F is an enlarged front elevation view of one of the display devices of FIGS. 1A and 1B illustrating the incrementing of the award prior to the fourth pick by the player.

FIG. 7G is an enlarged front elevation view of one of the display devices of FIGS. 1A and 1B illustrating a fourth pick by a player in one embodiment of a game of the present invention.

FIG. 7H is an enlarged front elevation view of one of the display devices of FIGS. 1A and 1B illustrating a fifth and final pick by a player in one embodiment of a game of the present invention.

FIG. 8 is an enlarged front elevation view of one of the display devices of FIGS. 1A and 1B illustrating another embodiment of the present invention where the indicators include alternative symbols such as letters.

FIG. 9 is an enlarged front elevation view of one of the display devices of FIGS. 1A and 1B illustrating another alternative embodiment of the present invention having multiple indicators.

FIG. 10 is a front perspective view of another alternative embodiment of the present invention where the symbol indicators are physical dice positioned in a housing attached to the cabinet gaming device.

FIG. 11 is a front perspective view of another embodiment of the present invention where each indicator is a mechanical die unit attached to the cabinet of the gaming device.

FIG. 12 is a table illustrating the difference between awards incremented by the exponential incrementor and awards that are not incremented by the exponential incrementor.

### DETAILED DESCRIPTION OF THE INVENTION

Gaming Device and Electronics

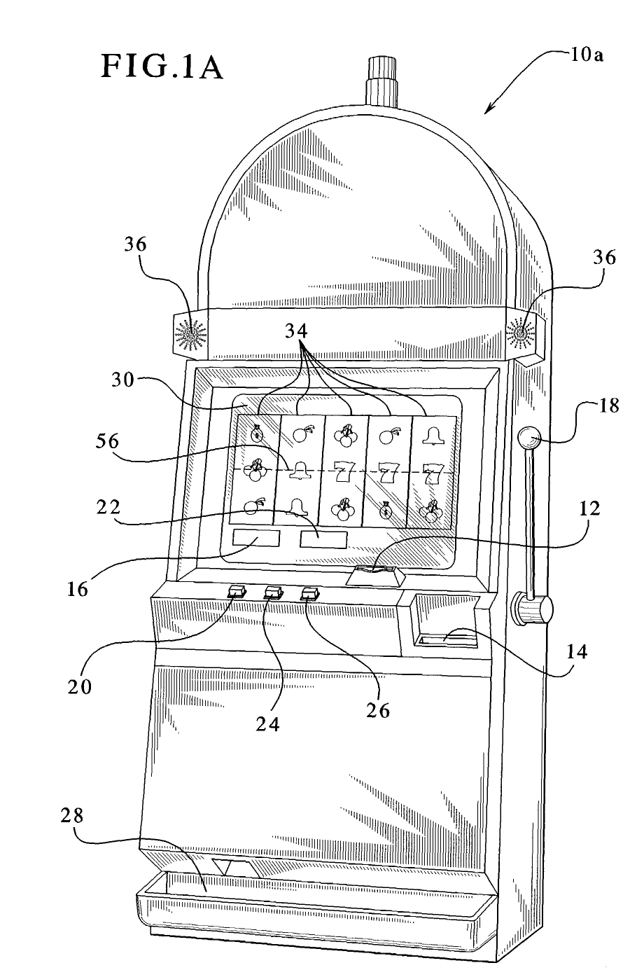

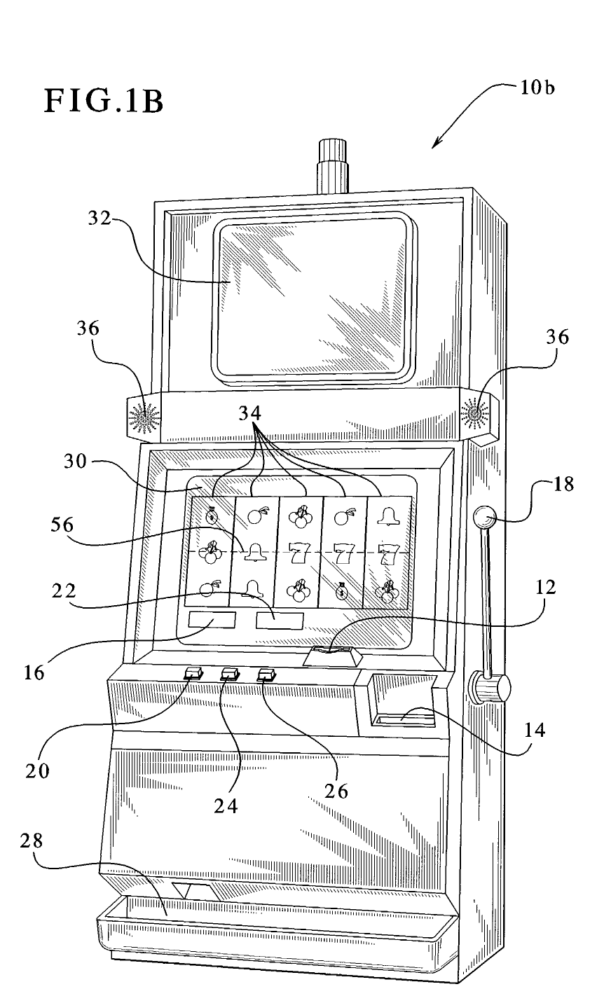

Referring now to the drawings, two embodiments of the gaming device of the present invention are illustrated in FIGS. 1A and 1B as gaming device 10a and gaming device 10b, respectively. Gaming device 10a and/or gaming device 10b are generally referred to herein as gaming device 10. Gaming device 10 in one embodiment has the controls, displays and features of a conventional slot machine. It is constructed so that a player can operate it while standing or sitting, and gaming device 10 is preferably mounted on a console. However, it should be appreciated that gaming device 10 can be constructed as a pub-style table-top game (not shown) which a player can operate preferably while sitting. Furthermore, gaming device 10 can be constructed with varying cabinet and display designs, as illustrated by the designs shown in FIGS. 1A and 1B. Gaming device 10 can also be implemented as a program code stored in a detachable cartridge for operating a hand-held video game device. Also, gaming device 10 can be implemented as a program code stored on a disk or other memory device which a player can use in a desktop or laptop personal computer or other computerized platform.

Gaming device 10 can incorporate any primary game such as slot, poker, blackjack or keno, any of their bonus triggering events and any of their bonus games. The symbols and indicia used on and in gaming device 10 may be in mechanical, electrical, electronic or video form.

As illustrated in FIGS. 1A and 1B, gaming device 10 includes a coin slot 12 and bill acceptor 14 where the player inserts money, coins or tokens. The player can place coins in the coin slot 12 or paper money or ticket vouchers in the bill acceptor 14. Other devices could be used for accepting payment such as readers or validators for credit cards or debit cards. When a player inserts money in gaming device 10, a number of credits corresponding to the amount deposited is shown in a credit display 16. After depositing the appropriate amount of money, a player can begin the game by pulling arm 18 or pushing play button 20. Play button 20 can be any play activator used by the player which starts any game or sequence of events in the gaming device.

As shown in FIGS. 1A and 1B, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. Other bet or wager indicators such as a bet max button may also be employed in the gaming device of present invention.

A player may cash out and thereby receive a number of coins corresponding to the number of remaining credits by pushing a cash out button 26. When the player cashes out, the player receives the coins in a coin payout tray 28. The gaming device 10 may employ other payout mechanisms such as credit slips redeemable by a cashier or electronically recordable cards which keep track of the player's credits.

Gaming device 10 also includes one or more display devices. The embodiment shown in FIG. 1A includes a central display device 30, and the alternative embodiment shown in FIG. 1B includes a central display device 30 as well as an upper display device 32. Gaming device 10 in one embodiment displays a plurality of reels 34 such as three to five reels 34 in mechanical or video form at one or more of the display devices. However, it should be appreciated that the display devices can display any visual representation or exhibition, including but not limited to movement of physical objects such as mechanical reels and wheels, dynamic lighting and video images. A display device can be any viewing surface such as glass, a video monitor or screen, a liquid crystal display or any other display mechanism. If the reels 34 are in video form, the display device for the video reels 34 is preferably a video monitor. Each reel 34 displays a plurality of indicia such as bells, hearts, fruits, numbers, letters, bars or other images which preferably correspond to a theme associated with the gaming device 10. Furthermore, gaming device 10 preferably includes speakers 36 for producing sounds such as music.

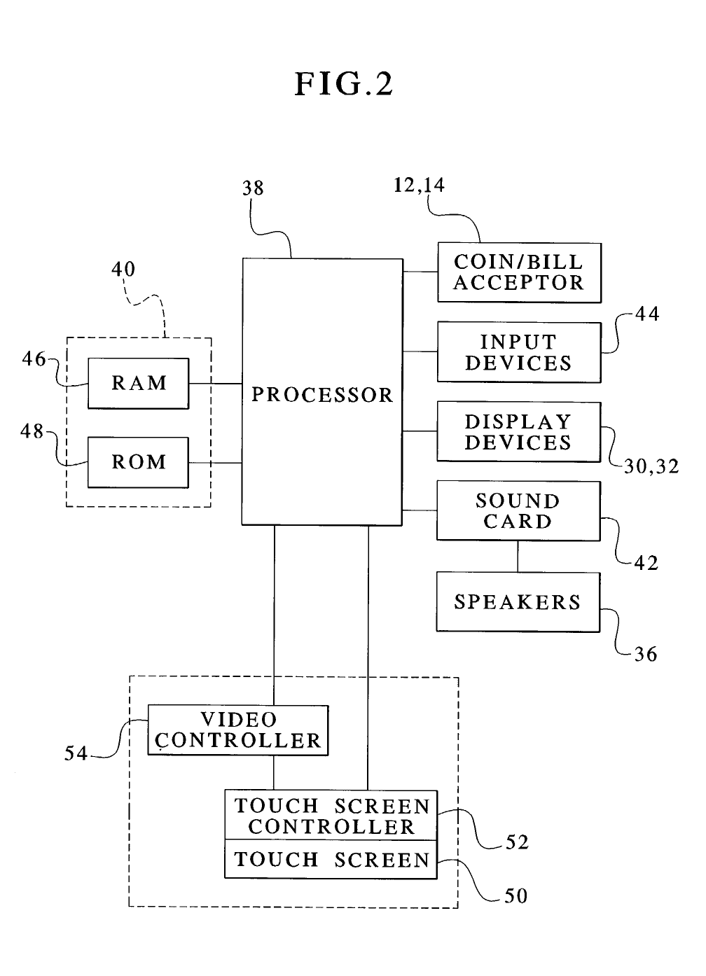

As illustrated in FIG. 2, the general electronic configuration of gaming device 10 preferably includes: a processor 38; a memory device 40 for storing program code or other data; a central display device 30; an upper display device 32; a sound card 42; a plurality of speakers 36; and one or more input devices 44. The processor 38 is preferably a microprocessor or microcontroller-based platform which is capable of displaying images, symbols and other indicia such as images of people, characters, places, things and faces of cards. One or more secondary processors may also be employed in conjunction with the primary processor to control certain aspects of the game function. The memory device 40 can include random access memory (RAM) 46 for storing event data or other data generated or used during a particular game. The memory device 40 can also include read only memory (ROM) 48 for storing program code which controls the gaming device 10 so that it plays a particular game in accordance with applicable game rules and pay tables.

As illustrated in FIG. 2, the player preferably uses the input devices 44, such as pull arm 18, play button 20, the bet one button 24 and the cash out button 26 to input signals into gaming device 10. In certain instances it is preferable to use a touch screen 50 and an associated touch screen controller 52 instead of a conventional video monitor display device. Touch screen 50 and touch screen controller 52 are connected to a video controller 54 and processor 38. A player can make decisions and input signals into the gaming device 10 by touching touch screen 50 at the appropriate places. As further illustrated in FIG. 2, the processor 38 can be connected to coin slot 12 or bill acceptor 14. The processor 38 can be programmed to require a player to deposit a certain amount of money in order to start the game.

It should be appreciated that although a processor 38 and memory device 40 are preferable implementations of the present invention, the present invention can also be implemented using one or more application-specific integrated circuits (ASIC's) or other hardwired devices, or using mechanical devices (collectively and alternatively referred to herein as a “processor”). Furthermore, although the processor 38 and memory device 40 preferably reside on each gaming device 10 unit, it is possible to provide some or all of their functions at a central location such as a network server for communication to a playing station such as over a local area network (LAN), wide area network (WAN), Internet connection, microwave link, and the like. The processor 38 and memory device 40 are generally referred to herein as the “computer” or “controller.” With reference to FIGS. 1A, 1B and 2, to operate the gaming device 10, in one embodiment the player must insert the appropriate amount of money or tokens at coin slot 12 or bill acceptor 14 and then pull the arm 18 or push the play button 20. The reels 34 will then begin to spin. Eventually, the reels 34 will come to a stop. As long as the player has credits remaining, the player can spin the reels 34 again. Depending upon where the reels 34 stop, the player may or may not win additional credits.

In addition to winning credits in this manner, in one embodiment gaming device 10 also gives players the opportunity to win credits in a bonus round. This type of gaming device 10 will include a program which will automatically begin a bonus round when the player has achieved a qualifying condition in the game. This qualifying condition can be a particular arrangement of indicia on a display device. The gaming device 10 may use mechanical devices or a video-based central display device 30 to enable the player to play the bonus round. In one embodiment, the qualifying condition is a predetermined combination of indicia appearing on a plurality of reels 34. As illustrated in the five reel slot game shown in FIGS. 1A and 1B, the qualifying condition could be the number seven appearing on three adjacent reels 34 along a payline 56. It should be appreciated that the present invention can include one or more paylines, such as payline 56, wherein the paylines can be horizontal, diagonal or any combination thereof.

Bonus Game

In one embodiment of the present invention, if a player achieves a bonus triggering or qualifying condition during the primary game, the gaming device 10 initiates the secondary or bonus game of the present invention. Referring now to FIG. 3, 4 and 5 in one embodiment of the bonus game of the present invention, the bonus game is initiated in accordance with the game scheme and rules as indicated by oval 100. In the game, the player attempts to accumulate incrementing awards before obtaining a terminator or using all of the player's activations or rolls.

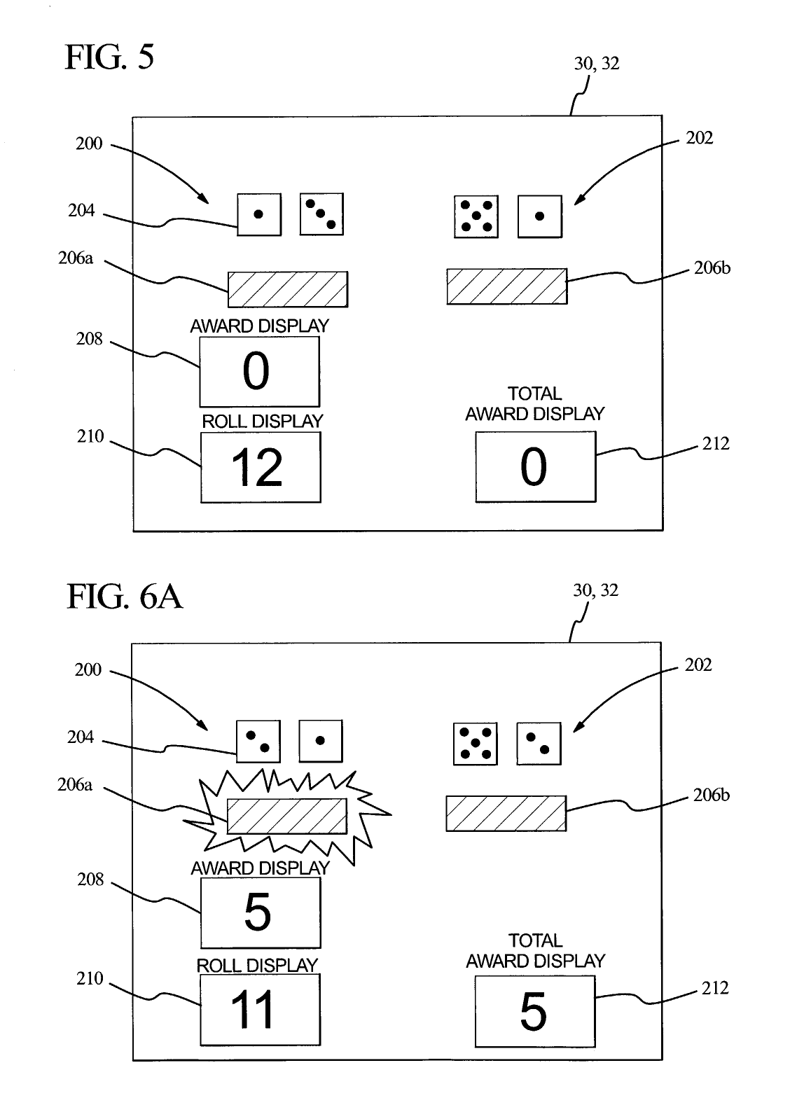

In one embodiment, the game display 30 or 32 includes two sets or groups of indicators having at least two symbol indicators in each such as two pair of dice having numbers one through six, corresponding selectors or buttons utilized by a player to select a pair of symbol indicators or dice to activate or roll the dice, an award or value display 208, a total award display 212, and a roll display 210 as generally illustrated in FIG. 5. In another embodiment, the gaming device displays only one pair of dice to the player. The gaming device repeatedly activates or spins that pair of dice until there are no activations or spins remaining in the game.

In the present embodiment, the bonus game begins by determining the number of activations or rolls that the player will receive in the game as indicated by block 102. The number of rolls may be determined randomly, predetermined or predefined, picked by the player from a plurality of masked selections or by any other suitable method. Next, the gaming device determines the initial award level for the first activation or roll in the bonus game and the award increments as indicated by block 104. The initial award level and increments may be randomly determined, predetermined, predefined, or determined by any suitable method desired by the game implementor. In one embodiment, once the initial award level is established, the subsequent award levels will double, or increment by two times the previous award level, after each activation or roll that does not result in a terminator. It should be appreciated that the subsequent award levels may increase by alternative amounts or values as desired by the game implementor. The game displays the dice to the player as indicated by block 106. It should be appreciated that in one preferred embodiment two pairs of dice are displayed to a player in the bonus game.

The game prompts the player to pick one pair of dice on the display as indicated by block 108. The prompt may be a message displayed on the display device 30 or 32, flashing or blinking buttons or any other suitable prompt desired by the game implementor. After the player selects one pair of dice from the display, the processor in this embodiment activates or rolls all of the pairs of dice as indicated by block 110. A roll is simulated by randomly changing the number values shown on the dice by using a random number generator or similar device that is in communication with processor 38. In one embodiment, all of the displayed pairs of dice are rolled to show the player the numbers generated by the pairs of dice that the player did not select. However, it should be appreciated that all pairs of dice do not need to be activated or rolled and that only one pair of dice, or one or more pairs of dice may be rolled at a time. After rolling the dice, the game subtracts one roll from the total number of rolls remaining in the game as indicated by block 112, which is reflected in the roll display 210 on the main display device 30 or 32 as illustrated in FIG. 5.

A number is generated for each pair of dice after rolling the dice. In one embodiment, the number generated by the pair of dice that was selected by the player is computed by summing the number value on each die. The processor 38 determines if this number is a predetermined terminator or terminating number as indicated by decision diamond 114. In one embodiment, the terminator or terminating number is the number seven. If the player receives the number seven, the terminator, the game ends as indicated by block 124. The total award received by the player during the game is added to any previous awards and provided to the player. It is contemplated that the terminator may be any value, symbol, or combination of values or symbols as desired by the game implementor.

A game may also include one or more terminators, terminator symbols or terminating numbers where the number of terminators in a bonus game varies based on the amount wagered in the base game. In one embodiment, the larger the wager in the base game, the greater the award in the bonus game. Thus, the game implementor may include fewer terminators in bonus games where a player wagered a larger amount in the base game and the bonus game is triggered. Increasing the number of terminators in the bonus game makes obtaining an award in the bonus game more difficult. Therefore, it should be appreciated that a game implementor could implement a bonus game where the number of terminators decrease in the bonus game in relation to an increase in the amount wagered in the base game.

Additionally, the terminator or terminators in a game may be based on a particular roll or rolls in a game. In one embodiment, the terminator is based on a particular roll such as a previous roll in a game. For example, in a game, the first roll determines the terminator in the game. Therefore, if the player rolls a pair of dice and the dice indicate a one and a three on the dice, then the combination of the one and three on the dice indicates the terminator in that game. If the player rolls the dice and the dice indicate a one and a three in one or more subsequent rolls, the game ends because the one and three combination is a terminator in the game. Any combinations of symbols or numbers on the dice may be a terminator in the game. In a further embodiment, the sum of the numbers or symbols indicated on a pair of dice is the terminator in the game. Therefore, if the player rolls the pair of dice and the dice indicate a one and three as the terminator, then any subsequent roll that indicates a one and three or any combination of numbers that, when added together, equal the sum of four (i.e., one plus three), then that also is a terminator and the game ends. It should be appreciated that any combination of numbers and/or any modification of the numbers may be a terminator in a game.

If the player does not receive a terminator, the game determines if the number obtained by the player includes an award accelerator or exponential incrementor such as doubles as indicated by decision diamond 116. An award accelerator or exponential incrementor such as doubles occurs when each die in the pair of dice selected by the player indicates the same number or related numbers. If the player receives an award accelerator or exponential incrementor such as doubles, then the player receives double or two times the award for that roll as indicated by block 118. If the player does not obtain doubles, the player receives the award for that roll as indicated by block 120. In either case, the game transfers and adds the award to the total award display, which shows the total value of the awards received by the player in the game prior to that roll.

The processor next determines if the player has any rolls remaining as indicated by decision diamond 122. If the player does not have any rolls remaining, the game ends as indicated by block 124, and the player receives the total accumulated award for that game. If the player has rolls remaining, the processor increments the bonus award level for the next roll as indicated by block 123. The award increment in one embodiment equals double or two times the present award level in the game. For example, if the present award level is ten, the bonus game increases that award level to twenty prior to the next roll. In another embodiment, the award increment or increase is two times, or double, the total award in the game. It should be appreciated that any award may be incremented or increase in a game and the increase may be any suitable amount. After one or more awards are increased, the bonus game repeats the above process as indicated by block 106. The bonus game displays two pair of dice to the player as indicated by block 106. The player may select the same pair of dice that they selected in the previous roll or rolls or they may select a different pair of dice for this roll. The player continues to select pairs of dice in the bonus game until the player either receives a terminator or until there are no rolls remaining.

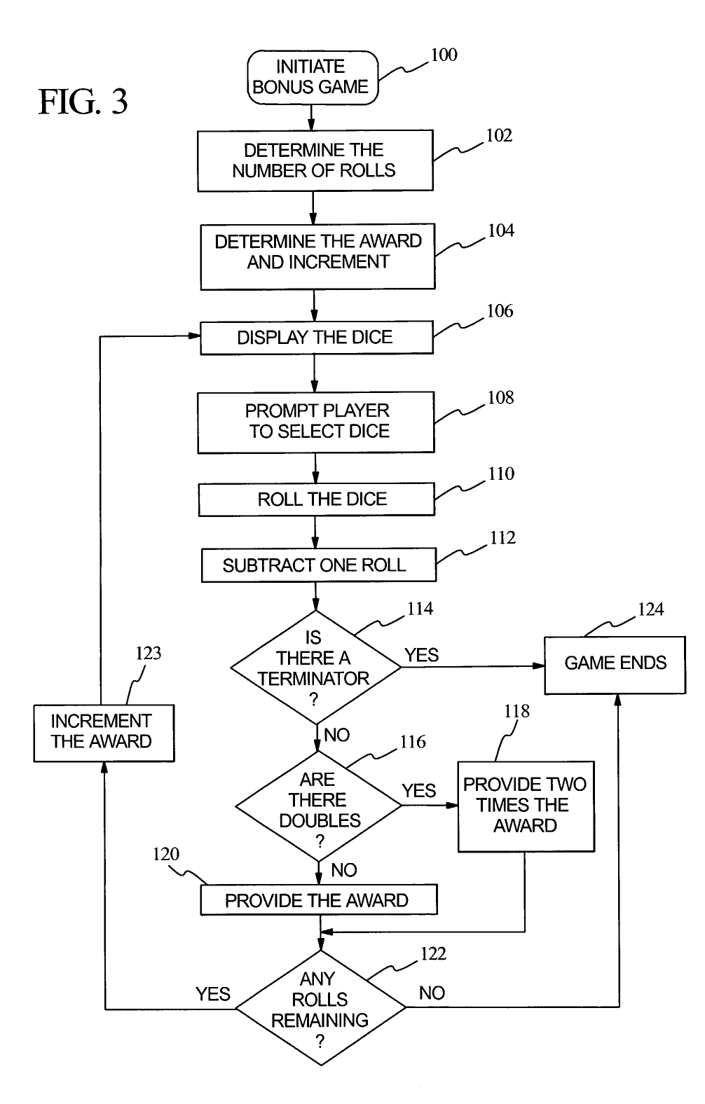

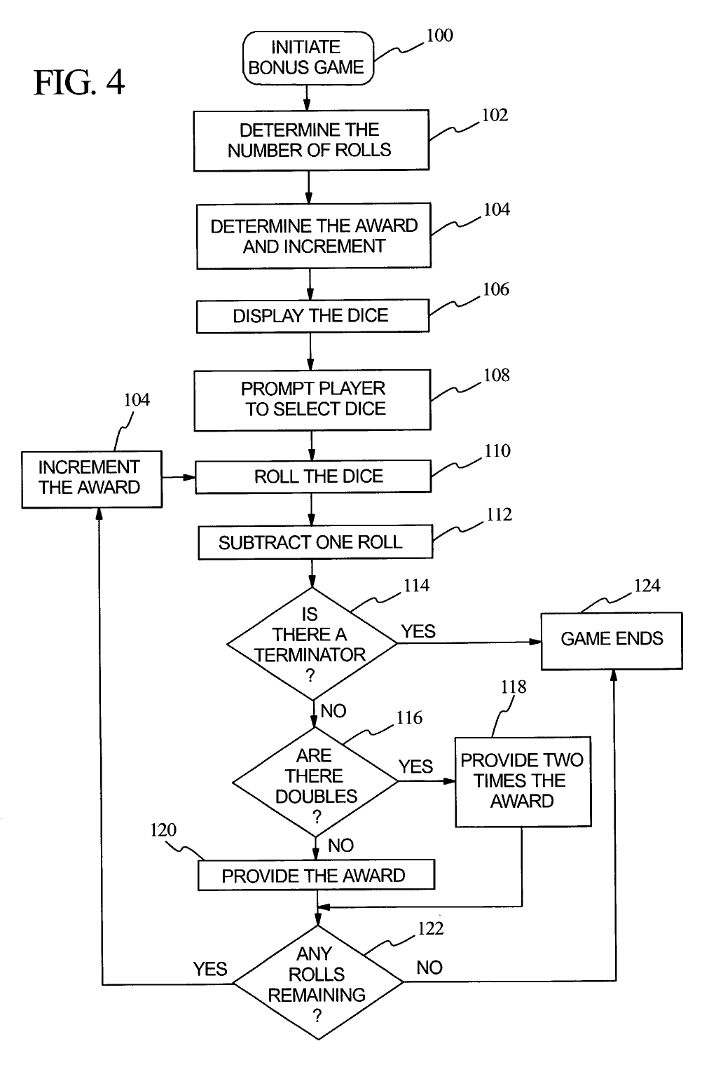

Referring now to FIG. 4, another embodiment of the present invention enables a player to select only one pair of dice at the beginning of the bonus game as indicated by block 108. In this embodiment, the player's award is only determined by the roll of one pair of dice. Although all pairs of dice are rolled in the bonus game, only the pair of dice picked by the player at the start of the bonus game is used to determine the player's award in that game. As indicated by decision diamond 122, the processor 38 determines if the player has any activations or rolls remaining in the bonus game. If the player has activations or rolls remaining, the gaming device increments the bonus award and then activations or rolls the same pair of selected dice again as shown in FIG. 4. The player does not receive a new opportunity to select a pair of dice after each roll, which occurred in the previous embodiment in FIG. 3. Instead the player selects only one pair of dice in the beginning of the game, and the game continues to roll that pair of dice until the player receives a terminator or until there are no rolls remaining. The present invention contemplates combinations of the embodiments of FIGS. 3 and 4 where the player can select the dice more than once, but not after each roll.

FIG. 5 illustrates one embodiment of the present invention at the beginning of a game. The display device 30 or 32 preferably displays a set or group of symbol indicators such as the two pair of dice 200 and 202, respectively. It should be appreciated that a game may have any number or type of sets or symbol indicators including one pair of dice or several pairs of dice. Furthermore, the dice used or depicted in a bonus game may be conventional-type dice having dots that represent numbers on multiple faces of the dies. It should be appreciated that dice having symbols, numbers, letters or other designations may be used in the bonus game. Also, dice having one or more sides may be used in the bonus game. It should also be appreciated that other symbol generators or number generators may be employed in accordance with the present invention.

In this embodiment, the gaming device prompts a player to select a pair of dice by highlighting the selectors 206a and 206b. In one embodiment, the buttons are highlighted by illuminating a light behind each button and then blinking or flashing that light to the player. Other methods of prompting a player to make a selection may be employed such as blinking or flashing the actual pairs of dice 200 and 202, presenting a message on the display screen, or any other method contemplated by the game implementor.

Once the buttons 206a and 206b prompt the player to make a selection, the player must decide which pair of dice the player will select for that roll and then press the corresponding button 206a or 206b for that pair of dice. After the player makes a selection and presses the corresponding selector, in one embodiment, the gaming device activates or rolls both pairs of dice 200 and 202 and randomly generates a number for each pair of dice. In one embodiment, the values on each die are the integers from one through six. In this embodiment, the total number for each pair of dice will be the integers from two through twelve. It should be appreciated that the dice or symbol indicators are not limited to these values. Other numbers, symbols, letters or values may be used on the dice or symbol indicators as desired by the game implementor.

After the processor generates a number for each pair of dice, the award value is displayed in award or value display 208. Prior to beginning the game, this number will be zero and may change after each roll to correspond with the award of the most recent roll of the selected pair of dice. In addition, the roll display 210 is updated after each roll. This display shows the number or amount of rolls remaining in a game. In FIG. 5, the roll display 210 indicates that the player has twelve rolls remaining in the game.

The total award for a game is shown in the total award display 212. If a player receives an award from a roll, the value of that award is reflected in the award display 208 and is added to the total award display 212. The display 212 shows the present value of all of the awards a player has accumulated during a game. The value indicated by total award display 212 at the end of a game is the award that the player receives for that bonus game.

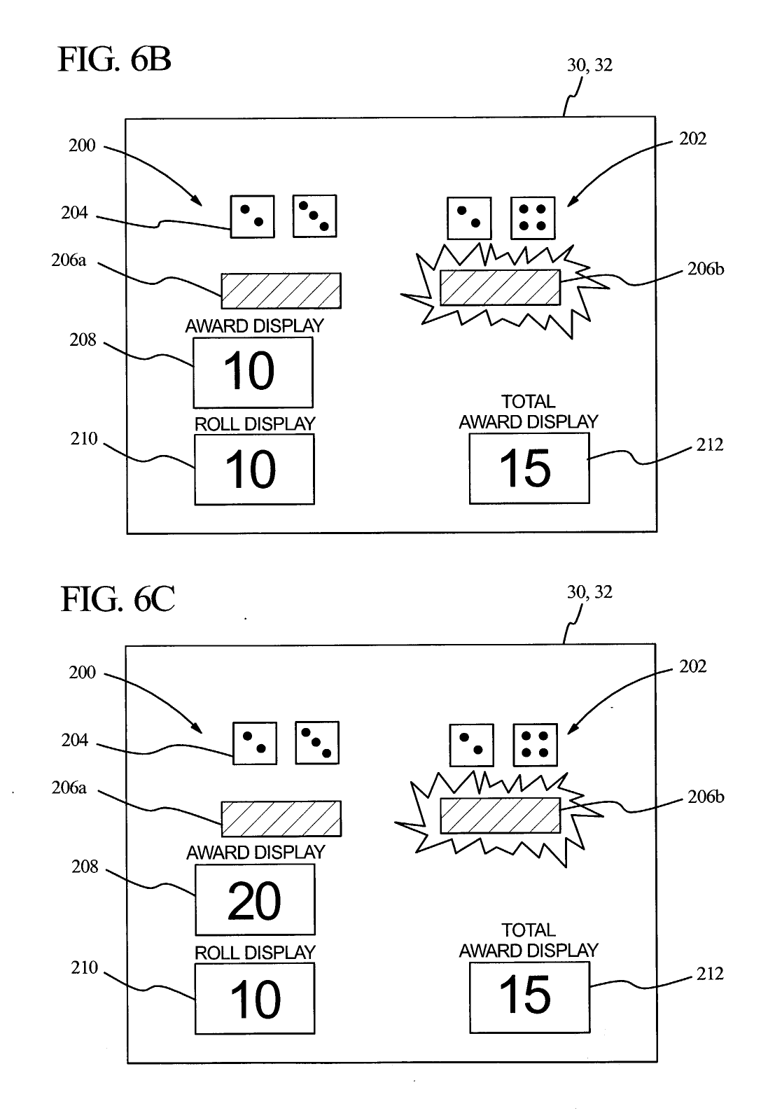

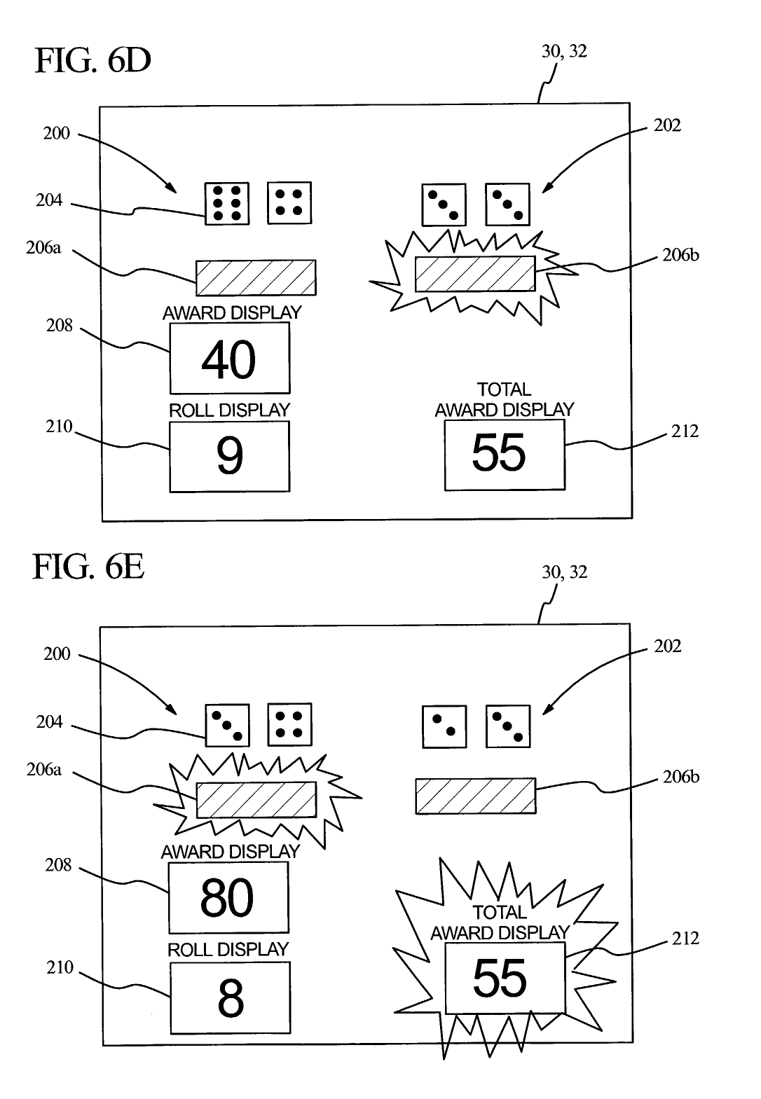

FIGS. 6A through 6D illustrate the first four rolls in an example game of this embodiment, and the different outcomes from those rolls. In this example, the game includes symbol indicators, which are two pair of dice 200 and 202, and the player starts the game with a limit of twelve activations or rolls. The player obtains an award for each roll that is not a terminator. There is one terminator in this embodiment which is the number seven. Therefore, if the player does not obtain a seven after the roll of their selected pair of dice, the player receives an award. In this embodiment, the award level or award starts at five for the first roll that is not a terminator, and doubles for each subsequent roll that does not result in a terminator.

The player begins the bonus game by pressing selectors 206a or 206b to choose the pair of dice that the player wants to activate or roll to start the game. The player selected the selection 206a associated with or corresponding to the pair of dice 200 as shown by the highlighted selector 206a. The processor rolls both pairs of dice and the results for each pair 200 and 202 are three and seven, respectively. The player receives a predetermined award value of five, as displayed in award display 208, for not obtaining a terminator after the first roll in the game. The roll display 210 now shows that the player has eleven rolls left in this bonus game. The total award display 212 indicates the player's present total award for the game, which is five. If the player would have selected the pair of dice 202, the game would have ended.

The processor increments or increases the award level to ten as illustrated in the display 208 in FIG. 6B. The award level ten is determined by incrementing or doubling initial award value of five. The player then makes their second selection of the game. The player chooses the right pair of dice 202 on the display screen shown by the highlighted selector 206b. After the gaming device activates or rolls both pairs of dice, the results for the dice pairs 200 and 202 are five and six, respectively. The player successfully rolled the selected pair of dice without getting a terminator. The player receives an award of ten for their second successful roll as is shown in value display 208. The award is added to the player's award from the first roll, five, for a total award of fifteen as indicated by total award display 212. The player now has only ten rolls remaining as indicated by roll display 210.

The processor now increments or increases the award level to twenty before the next roll as illustrated in FIG. 6C. In FIG. 6D, the player selects the right pair of dice 202 again, as illustrated by the highlighted selector 206b. After both pairs of dice are rolled or randomly determined by the processor, the results for dice pairs 200 and 202 are ten and six, respectively. The result for pair 202, however, is an award accelerator such as doubles (i.e., each die indicates the same number which is three). In this embodiment, the player receives twice the present award level of twenty for that roll which is forty. The award of forty is determined by doubling the award for that roll. This award is added to the previous total award of fifteen and results in a new total award of fifty-five as shown in total award display 212. The player now has only nine rolls remaining as indicated by roll display 210.

The award level doubles to 80 prior to the next roll. It should be appreciated that this award is based on doubling the existing award level of 40 instead of the previous award level of 20. Accordingly, obtaining an award accelerator such as doubles increases the award levels from the previous award level. Referring to FIG. 6E, the player picks the left pair of dice 200 as shown by highlighted selector 206a. After rolling both pairs of dice, the results are seven for pair 200 and five for pair 202. Since seven is a terminator in this embodiment, the game ends after that roll. In one embodiment, the player does not receive an award for receiving the terminator and the player receives the total award accumulated during the game as indicated by total award display 212, which is fifty-five. Although the player had eight rolls remaining in the game, the game ended because they received a terminator in that roll. Otherwise the game would have ended when the player used all of the activations or rolls in the game.

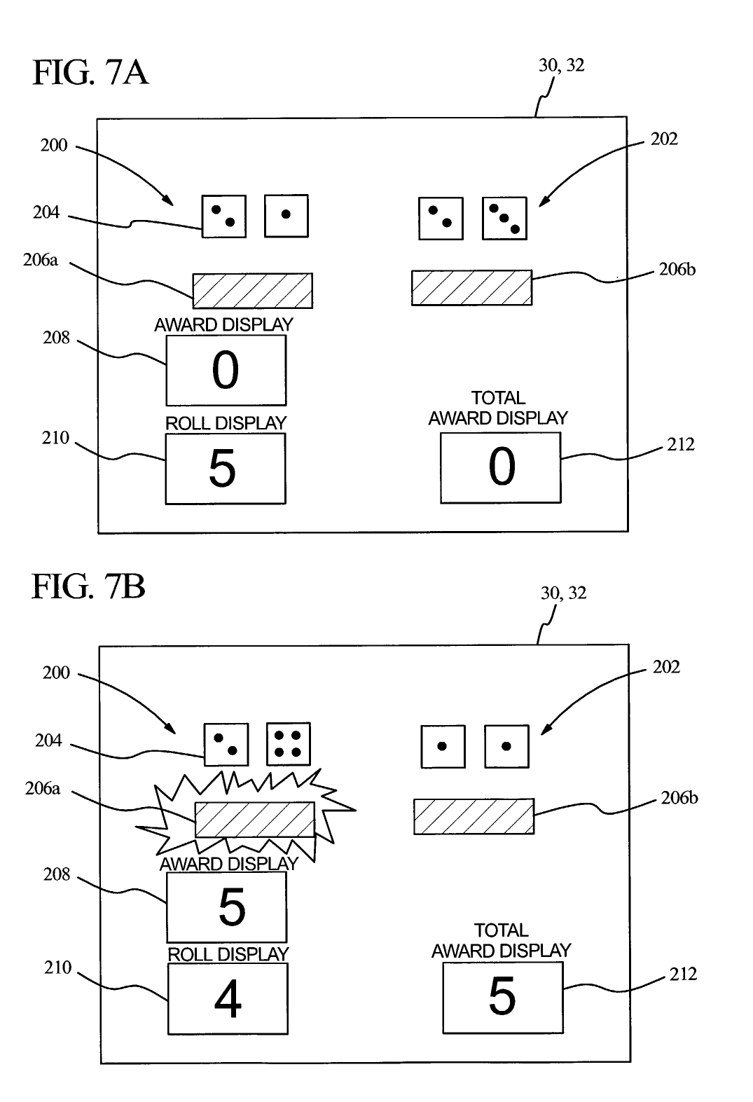

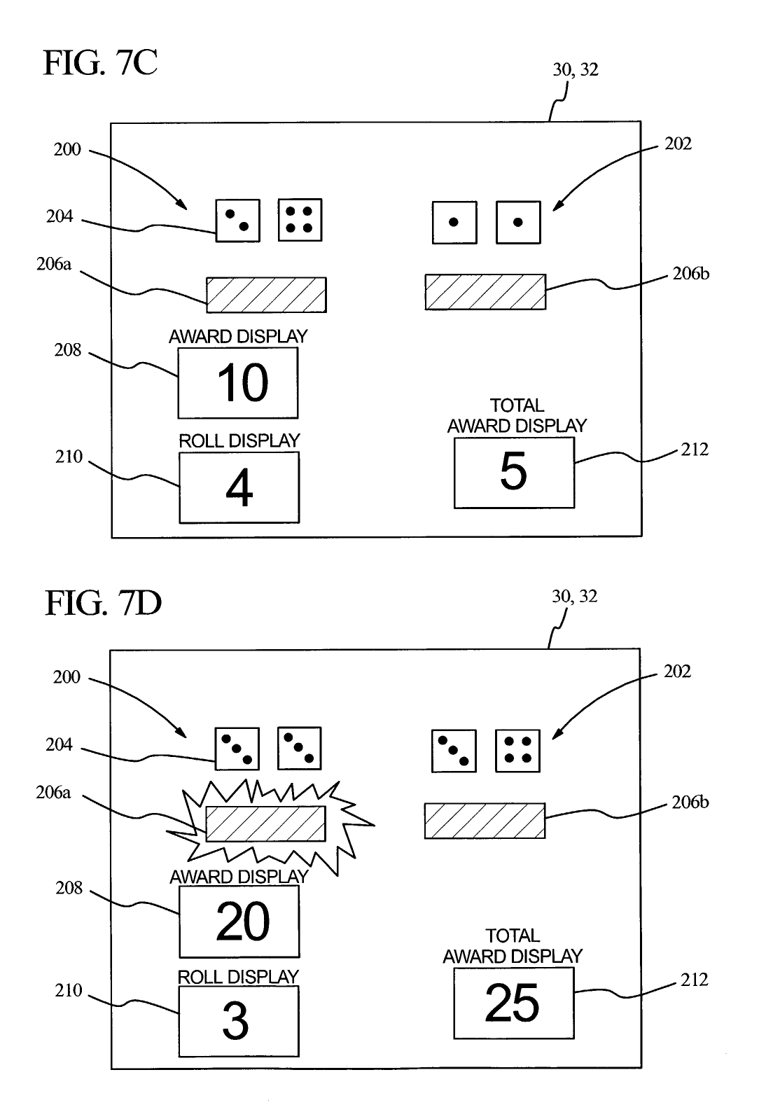

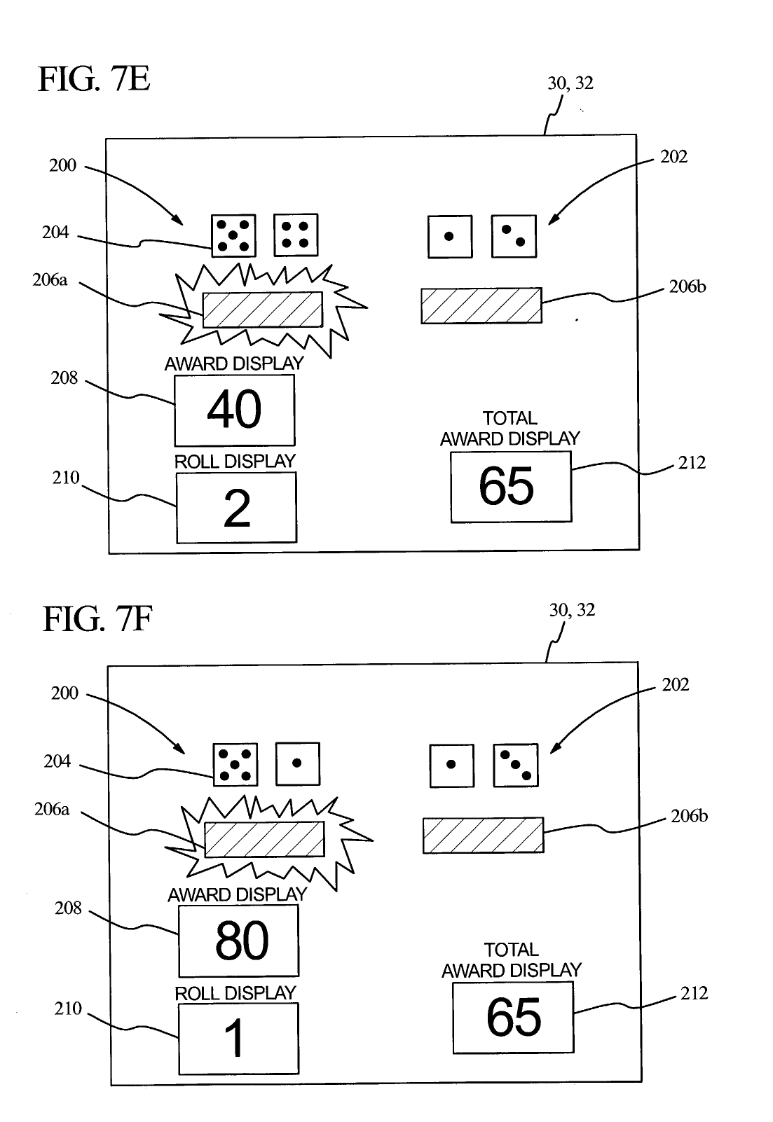

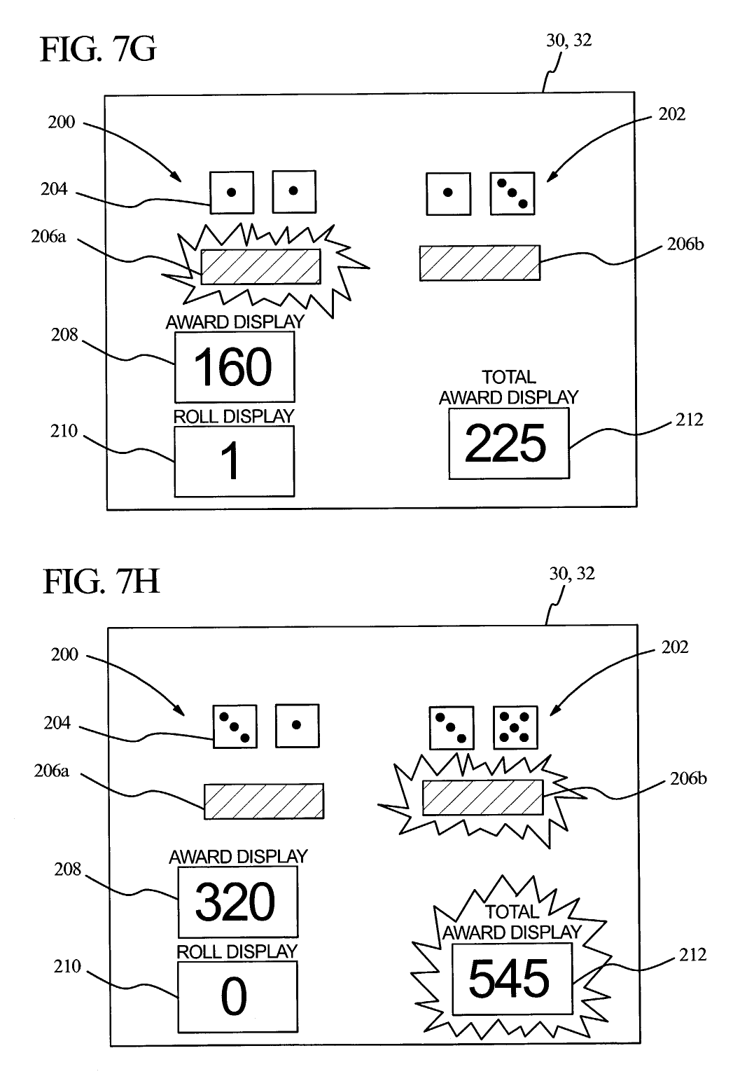

Referring now to FIGS. 7A to 7F, another example of the above embodiment in FIGS. 6A to 6E is illustrated. In this example, the game starts with one terminator, which is seven. The player does not have any previous awards as indicated by award display 212. Also, the player starts the game with five activations or rolls as indicated by roll display 210.

In FIG. 7B, the game begins with an initial award of five and the player chooses the left pair of dice 200 on the display device as shown by the highlighted selector 206a. The gaming device rolls both pairs of dice and the results for dice pairs 200 and 202 are six and two, respectively. Because the player chose dice pair 200, the player receives an award for not obtaining a terminator. The first award is five, where the awards increment by two or double after each subsequent roll. The player receives the award, five, as indicated by award display 212. There are only four rolls remaining in the game as indicated by roll display 210. In FIG. 7C, the processor in the gaming device increments the award or award level to ten prior to the next roll.

For the next roll, the player picks dice pair 200 again as shown by the highlighted selector 206a in FIG. 7D. The gaming device activates or rolls both pairs of dice and the results are six and seven for dice pairs 200 and 202, respectively. Again the player avoided a terminator. However, the player did obtain doubles as indicated by the matching threes on dice pair 200. In this embodiment, the award value increments by two or doubles every time a player obtains doubles in the game. Thus, the award value for this roll is twenty. Twenty is determined by taking the award for this roll, if the roll did not result in a terminator or doubles, which is ten, and doubling it. Now, the gaming device will increment this award by twenty (which is the next award level in the game for a roll that is not a terminator or doubles) prior to the next roll. The award, twenty, is added to the previous award total, five, to obtain the new total award for the bonus game of twenty-five as indicated by total award display 212. The subsequent awards are now incremented from the new award level of twenty. Therefore, the award for the next roll, if the player does not roll doubles, is forty. The player has three rolls remaining as indicated by roll display 210.

Referring to FIG. 7E, the player picks dice pair 200 as indicated by the highlighted selector 206a. After the gaming device rolls the dice, the results are a nine for dice pair 200 and three for dice pair 202. The player again avoids a terminator and therefore, receives an award. As described above, the award value is forty since the player did not obtain doubles with this roll. However by obtaining doubles with the previous roll, the player has increased the award levels so that any subsequent awards that the player receives will be substantially larger awards than if the player did not obtain doubles. The larger awards provide greater excitement and entertainment for players. The award, forty, is added to the player's total award and results in a new total award of sixty-five as indicated by award display 212. There are two rolls remaining in the game as indicated by roll display 210.

Referring to FIG. 7F, the processor in the gaming device increments the award or award level to eighty prior to the next roll. In FIG. 7G, the player picks dice pair 200 and obtains doubles again because each die in dice pair 200 resulted in the same symbol or number, one. The award for this roll, without obtaining a terminator or doubles, is eighty (i.e., twice the previous award of forty). Therefore, the player receives double this award, or one hundred sixty, for rolling doubles. As this award indicates, a player can obtain substantially larger awards as the player continues to successfully roll the dice in the bonus game. The award value, one hundred sixty, is added to the total award, sixty-five, and becomes two hundred twenty-five as indicated by the total award display 212. The player only has one roll left in the bonus game as indicated by roll display 210.

Referring to FIG. 7H, the player picks dice pair 202 for their last roll in the bonus game as indicated by the award display 208, the award for this roll is three hundred twenty. The gaming device activates or rolls both pairs of dice and the results for dice pairs 200 and 202 are four and eight, respectively. The player did not obtain a terminator or doubles with this roll. The player does receive the award of three hundred twenty. Three hundred twenty is the incremented award value for this roll based on doubling the award value from the previous roll, which was one hundred sixty. The player's final total award is five hundred forty-five for this bonus game as indicated by total award display 212.

FIGS. 6A to 6E and 7A to 7H illustrate how a player can obtain much larger awards with the bonus game of the present invention. In a further embodiment, the award accelerator doubles or increases the prior and present awards in a game (i.e., the total award). It should be appreciated that the award accelerator may increase any suitable award in a game. Thus, the player's excitement and entertainment levels build as the player progresses further and further into the bonus game.

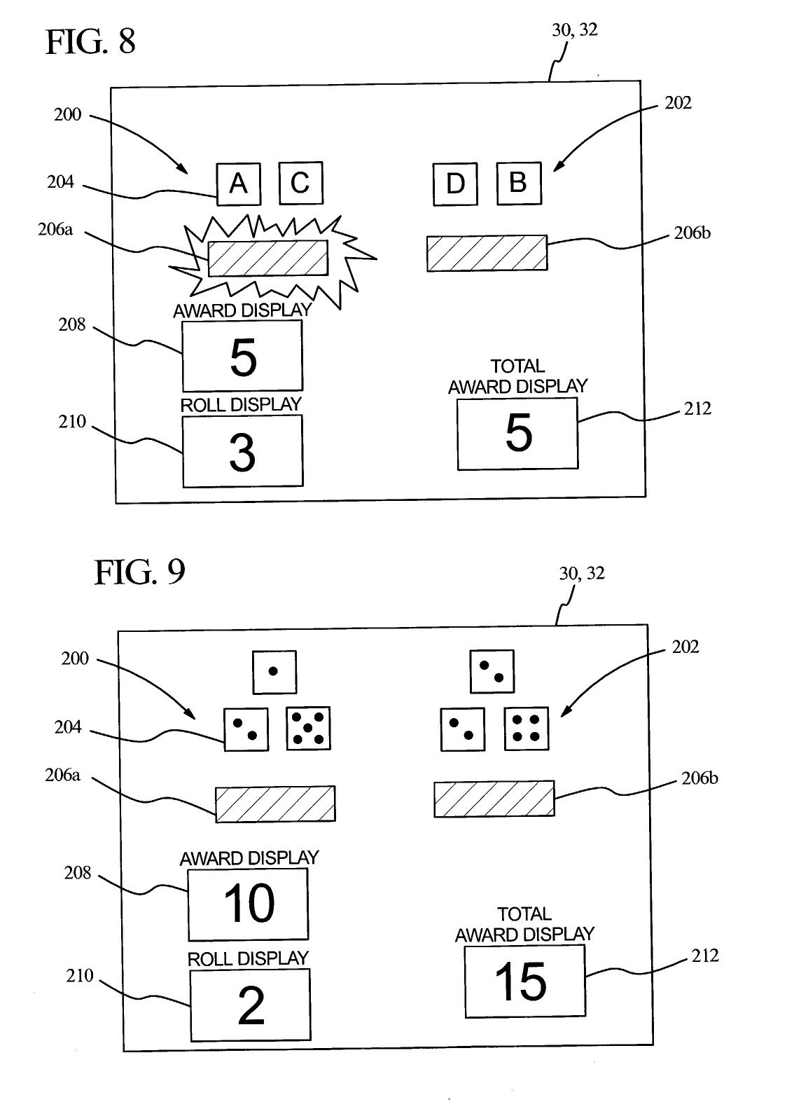

Now referring to FIG. 8, another embodiment of the present invention is illustrated where the sets of symbol indicators have letters instead of numbers, or dots representing numbers. In this embodiment, the gaming device activates or rolls the indicators to obtain letter combinations. As described in the other embodiments, the player picks a set of symbol indicators and obtains the letter combination for those selected indicators. The letter combinations are associated with awards that increment after each roll. Thus, the bonus game may include symbol indicators that have numbers, letters, symbols or any other designation as desired by the game implementor.

Referring to FIG. 9, a further embodiment of the present invention is illustrated where there are three symbol indicators or dice for each set and associated selectors 206a and 206b. In this embodiment, the player picks a set or group of dice, 200 or 202, in the bonus game. The gaming device activates or rolls both sets of dice and randomly generates a number for each set. As described earlier, if the picked set or group of dice generates a number that is equal to a terminator, the game ends. If the player obtains triples, or three of the same symbol or number on each die, the player's award exponentially increments accordingly. Therefore, this embodiment illustrates that a bonus game may have one or several symbol indicators, such as dice, in a game as desired by the game implementor.

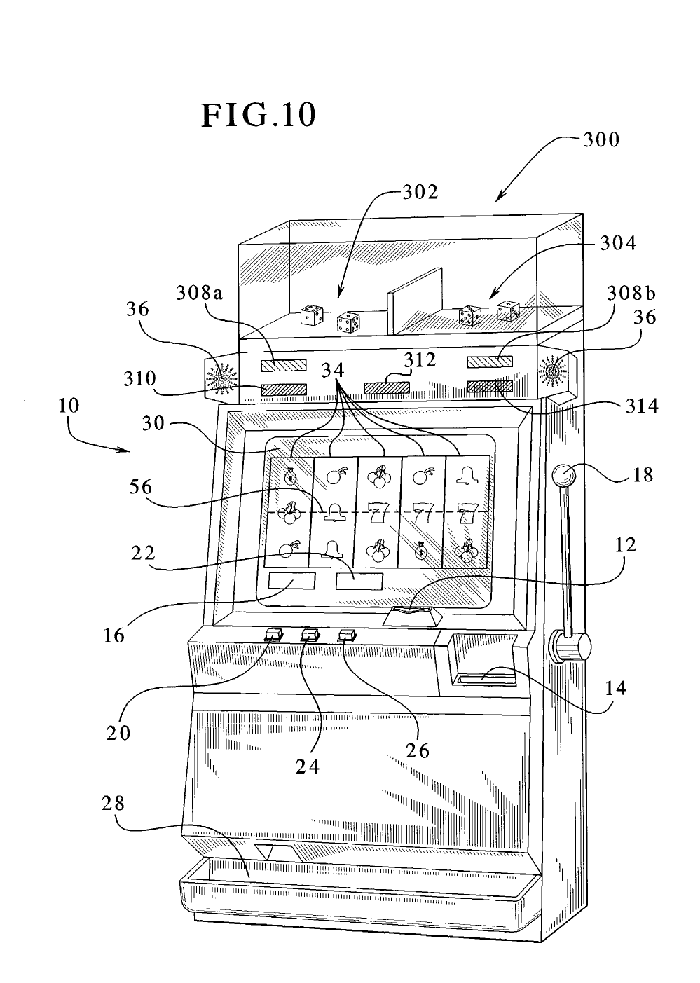

FIG. 10 illustrates another embodiment of the present invention which utilizes a physical display as opposed to a video display of the previous embodiment. In this embodiment, the game is played with physical indicators such as the sets of dice 302 and 304, enclosed in a suitable housing 300. The housing 300 may be situated on the top portion of the cabinet of the gaming device 10 and is attached thereto. However, the housing is not limited to the top portion of the gaming device 10 and may be positioned in any manner in relation to the gaming device that allows a player to view the sets of dice inside the housing 300.

One or more sensors (not shown) are positioned and attached inside the housing 300 to sense or detect symbols or numbers indicated by the dice. Furthermore, activators (not shown) such as mechanical activators activate, roll or move the dice for each activation or roll of the dice by a player.

The selectors 308a and 308b are located on the gaming device 10 and are used to select the pairs of dice 302 and 304, respectively. The award or value display 310, roll display 312 and total award display 314 are also located on the gaming device 10. However, the selector buttons 308a and 308b, and displays 310, 312 and 314 may be located at any suitable position on the gaming device 10 or housing 300 as desired by a game implementor.

In FIG. 10, the dice may be physically activated or rolled by any one of several different methods. In one aspect of the present invention, the housing 300 is placed at an angle and the dice are positioned at the top of a ramp (not shown) inside the housing. Then the dice are allowed to roll down the incline to produce a roll value. In another embodiment, the pairs 302 and 304, may be vibrated or moved with a pulse of air from the bottom side of the housing 300 such that the dice change position and produce a new roll value.

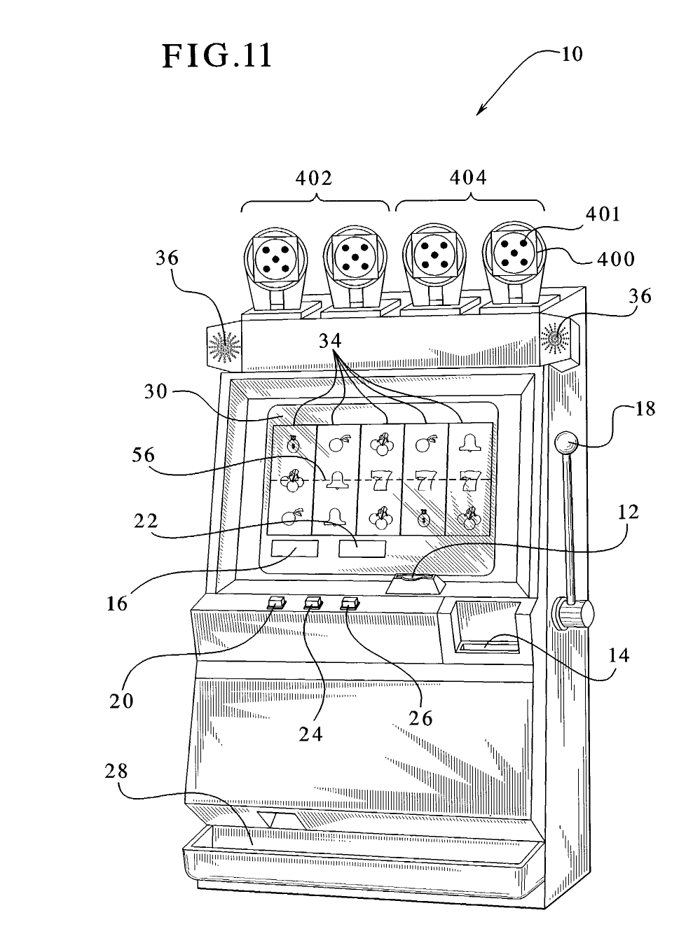

In yet another embodiment shown in FIG. 11, a roll is simulated by dice units 400. An example of the type of dice unit that may be used for this embodiment is manufactured by Starpoint Electronics, Ltd. (Model 1DU). Each dice unit 400 rotates an enlarged die 401 that is attached to each unit. Once the rotation stops, each die stops and produces a number. In this embodiment the dice units 400 would be attached to the top of the gaming device 10 in pairs 402 and 404 to represent the pairs of dice in the present invention. Also, the units are electrically connected to the processor 38, which would control the movement of each unit. It should be appreciated that the implementor may employ any desired method, in addition to those described above, to activate or roll the dice.

In one embodiment, the probabilities associated with the number combinations equal the actual probability of each number being indicated on the indicators or dice after the indicators or dice are activated or rolled. For example, the probability associated with the number seven being indicated on a pair of dice is equal to 6/36 or 16.67%. The probability associated with the number one is 0% because the number one cannot be obtained from a pair of dice. In an alternative embodiment, a probability of being indicated is associated with each symbol or number combination generated by the symbol indicators such that the probability associated with one symbol or number combination is greater than the probability associated with another symbol or number combination.

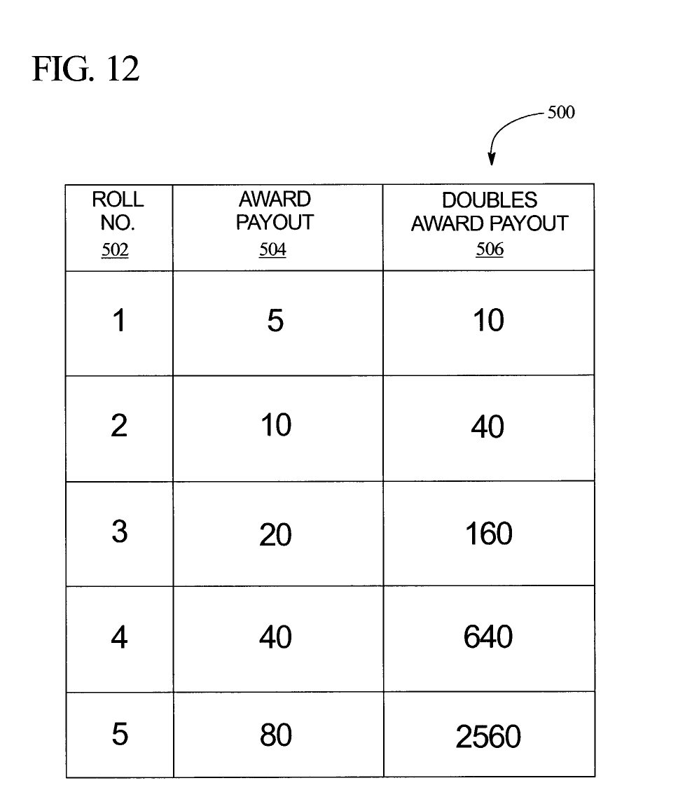

Referring now to FIG. 12, table 500 further illustrates the effect of the award accelerator on the award levels during a secondary or bonus game. The table compares the different awards provided to a player when the player does not obtain the award accelerator or doubles in a bonus game (as shown in Column 504) and when the player obtains doubles after every activation or roll in the bonus game (as shown in Column 506). Column 502 shows the first five activations or rolls in the bonus game. For this example, the awards double after each activation or roll that does not result in a terminator or doubles.

As illustrated in Column 504, if the player does not obtain doubles with any of the player's rolls in the bonus game, the award levels increment by two or double after each roll. Thus, the player obtains the initial award of five after the first roll, and then the awards of ten, twenty, forty and eighty, respectively, for the next four rolls.

In Column 506, however, all of the awards are incremented by the award accelerator because the player obtains doubles, or the same symbol on each die, after each roll in the bonus game. In the first activation or roll, the player obtained doubles and therefore received twice the initial award of five, which is ten. In the second roll, the player obtained doubles again. Thus, the player receives an award of forty or two times the award of twenty, which would have been the award provided in the second roll if the player did not obtain doubles. The second roll further illustrates how the award accelerator substantially increases the awards or award levels in the bonus game. When a player receives an increased award by obtaining doubles in a bonus game, the subsequent awards are incremented from the increased award level, not from the original award levels. Thus, the awards are increased from the previous award level, which substantially increases the awards in the bonus game.

In the third roll, the player obtains doubles again. The award accelerator increments or increases the award for the third roll to one hundred sixty. The increased award is double the award level of eighty, which would have been the award provided to the player if the player did not obtain doubles in that roll. Similarly, the award accelerator increases the awards, or doubles the awards, after the fourth and fifth rolls after the player obtained doubles in those rolls. As shown in Column 506, the awards are increased to six hundred forty and two thousand five hundred sixty, respectively. Thus, the award accelerator dramatically increases or increments the awards in the bonus game and thereby provides the players with increased excitement and enjoyment of the game.

Although the present invention is primarily discussed relative to a secondary or bonus game, it should be appreciated that the present invention could be employed as a primary game in a gaming device.

Moreover, although the present invention is primarily discussed with multiple pairs of dice or symbol indicators, the present invention may employ a single set of symbol indicators or dice. In this embodiment, the gaming device would activate or roll the same pair of dice in each activation until the symbol indicators indicate a terminator or until there are no activations remaining in the game.

While the present invention has been described in connection with what is presently considered to be the most practical and preferred embodiments, it is to be understood that the invention is not limited to the disclosed embodiments, but on the contrary is intended to cover various modifications and equivalent arrangements included within the spirit and scope of the claims. It is thus to be understood that modifications and variations in the present invention may be made without departing from the novel aspects of this invention as defined in the claims, and that this application is to be limited only by the scope of the claims.

The invention is claimed as follows:

1. A gaming device comprising:
a set of symbol indicators including at least two symbol indicators having a plurality of symbols thereon;
an award accelerator including a combination of one of the symbols on one of the symbol indicators and one of the symbols on another of the symbol indicators; and
a processor which randomly activates the symbol indicators for a plurality of activations, causes the symbol indicators to indicate one of the symbols on each symbol indicator in each activation, provides an award to a player in each of said activations, and increases the award when the indicated combination of symbols on the symbol indicators is the award accelerator in any of the activations.

2. The gaming device of claim 1, wherein the symbols on the symbol indicators include a terminator symbol, whereby the activations of the symbol indicators terminate when the terminator symbol is indicated by at least one of the symbol indicators in the set.

3. The gaming device of claim 1, which includes a terminator including a combination of one of the symbols on one of the symbol indicators and one of the symbols on another of the symbol indicators, wherein the activations of the symbol indicators ends when said terminator is indicated on the symbol indicators.

4. The gaming device of claim 3, which includes a probability of occurring associated with said terminator.

5. The gaming device of claim 3, wherein said probability of said terminator occurring changes in each activation of the symbol indicators.

6. The gaming device of claim 3, wherein said probability of said terminator occurring changes in a plurality of activations of the symbol indicators.

7. The gaming device of claim 3, wherein said processor randomly determines if said probability of said terminator occurring changes for each activation of the symbol indicators.

8. The gaming device of claim 3, wherein said processor randomly determines if said probability of said terminator occurring changes in a plurality of activations of the symbol indicators.

9. The gaming device of claim 1, which includes a terminator including a combination of one of the symbols on one of the symbol indicators and one of the symbols on another of the symbol indicators in a first one of the activations, wherein the activations of the symbol indicators ends when said terminator symbol is indicated on the symbol indicators in a subsequent activation to said first activation.

10. The gaming device of claim 1, which includes a terminator including a sum of a combination of one of the symbols on one of the symbol indicators and one of the symbols on another of the symbol indicators in a first one of the activations, wherein the activations of the symbol indicators ends when said terminator symbol is indicated on the symbol indicators in a subsequent activation to said first activation.

11. The gaming device of claim 1, which includes a terminator including a plurality combinations of one of the symbols on one of the symbol indicators and one of the symbols on another of the symbol indicators in a first one of said activations, wherein the activations of the symbol indicators ends when said terminator symbol is indicated on the symbol indicators in a subsequent activation to said first activation.

12. The gaming device of claim 1, which includes a plurality of sets of symbol indicators, wherein each of said sets includes at least two symbol indicators having a plurality of symbols thereon and wherein at least one of the sets of symbol indicators is activated in each activation.

13. The gaming device of claim 12, wherein said activated set is randomly determined.

14. The gaming device of claim 12, wherein said activated set is predetermined.

15. The gaming device of claim 12, which includes a selector associated with the sets of symbol indicators which enables the player to select and activate one of the sets.

16. The gaming device of claim 12, which includes a plurality of selectors associated with the sets of symbol indicators which enables the player to select and activate at least one of the sets.

17. The gaming device of claim 1, wherein the number of activations is predetermined.

18. The gaming device of claim 1, wherein the number of activations is randomly determined.

19. The gaming device of claim 1, which includes a plurality of award accelerators on the symbol indicators.

20. The gaming device of claim 1, which includes a probability of being indicated associated with said award accelerator.

21. The gaming device of claim 20, wherein said probability of said award accelerator being indicated changes in each activation of the symbol indicators.

22. The gaming device of claim 20, wherein said probability of said award accelerator being indicated changes in a plurality of activations of the symbol indicators.

23. The gaming device of claim 20, wherein said processor randomly determines if the probability of said award accelerator being indicated changes in each activation of the symbol indicators.

24. The gaming device of claim 20, wherein said probability of said award accelerator being indicated changes in a plurality of activations of the symbol indicators.

25. The gaming device of claim 1, wherein the award accelerator includes identical symbols.

26. The gaming device of claim 1, wherein the award increases by a randomly determined amount when the indicated combination of symbols on the symbol indicators is the award accelerator.

27. The gaming device of claim 1, wherein the award increases by a predetermined amount when the indicated combination of symbols on the symbol indicators is the award accelerator.

28. The gaming device of claim 1, wherein the award provided to the player in each activation is at least one of the awards selected from the group consisting of: an award in a previous activation, an award in the present activation, a multiplier in the previous activation and a multiplier in the present activation.

29. A gaming device comprising:
at least two sets of symbol indicators, each set having at least two symbol indicators with a plurality of symbols thereon;
an award accelerator including a combination of one of the symbols on one of the symbol indicators and one of the symbols on another of the symbol indicators of the same set; and
a processor which activates the symbol indicators in one of the sets in each activation of a plurality of activations, causes the symbol indicators in the activated set to indicate one of the symbols on each symbol indicator in said set, provides an award to a player in each activation, and increases the award when the indicated combination of symbols on the symbol indicators in the activated set is the award accelerator.

30. The gaming device of claim 29, wherein the set to be activated is randomly determined.

31. The gaming device of claim 29, wherein the set to be activated is predetermined.

32. The gaming device of claim 29, which includes a selector associated with the sets of symbol indicators which enables a player to select and activate one of the sets.

33. The gaming device of claim 29, which includes a plurality of selectors associated with the sets of symbol indicators which enable a player to select and activate at least one of the sets.

34. The gaming device of claim 29, wherein the symbol indicators in a plurality of the sets are activated, and wherein one of the symbols on each symbol indicator in the plurality of activated sets is indicated in each activation.

35. The gaming device of claim 29, wherein the symbol indicators in all of the sets are activated, and wherein one of the symbols on each symbol indicator in the activated sets is indicated in each activation.

36. The gaming device of claim 29, which includes a terminator symbol associated with at least one symbol indicator, wherein the game terminates when the terminator symbol is indicated by the activated set of symbol indicators.

37. The gaming device of claim 29, which includes a terminator including a combination of one of the symbols on one of the symbol indicators and one of the symbols on another of the symbol indicators in each set of symbol indicators, wherein the terminator and the award accelerator include different combinations and wherein the activations terminate when the indicated combination in the activated set of symbol indicators is the terminator.

38. The gaming device of claim 37, which includes a probability of occurring associated with said terminator.

39. The gaming device of claim 38, wherein said probability of said terminator occurring changes in each activation of the symbol indicators.

40. The gaming device of claim 38, wherein said probability of said terminator occurring changes in a plurality of activations of the symbol indicators.

41. The gaming device of claim 38, wherein said processor randomly determines if said probability of said terminator occurring changes in each activation of the symbol indicators.

42. The gaming device of claim 38, wherein said processor randomly determines if said probability of said terminator occurring changes in a plurality of activations of the symbol indicators.

43. The gaming device of claim 29, which includes a terminator including a combination of one of the symbols on one of the symbol indicators and one of the symbols on another of the symbol indicators in at least one of the activated sets in one of said activations, wherein the activations of the symbol indicators ends when said terminator symbol is indicated on the symbol indicators in the activated set in a subsequent activation.

44. The gaming device of claim 29, which includes a terminator including a sum of a combination of one of the symbols on one of the symbol indicators and one of the symbols on another of the symbol indicators in at least one of the activated sets in one of said activations, wherein the activations of the symbol indicators ends when said terminator symbol is indicated on the symbol indicators in the activated set in a subsequent activation.

45. The gaming device of claim 29, which includes a terminator including a plurality of combinations of one of the symbols on one of the symbol indicators and one of the symbols on another of the symbol indicators in at least one of the activated sets in one of the activations, wherein the activations of the symbol indicators ends when said terminator symbol is indicated on the symbol indicators in the activated set in a subsequent activation.

46. The gaming device of claim 29, which includes a plurality of award accelerators in at least one of the sets of symbol indicators.

47. The gaming device of claim 29, which includes a probability of being indicated associated with said award accelerator.

48. The gaming device of claim 47, wherein said probability of said award accelerator being indicated changes in each activation of the symbol indicators.

49. The gaming device of claim 47, wherein said probability of said award accelerator being indicated changes in a plurality of activations of the symbol indicators.

50. The gaming device of claim 47, wherein said processor randomly determines the probability of said award accelerator being indicated changes in each activation of the symbol indicators.

51. The gaming device of claim 47, wherein said processor randomly determines the probability of said award accelerator being indicated changes in a plurality of activations of the symbol indicators.

52. The gaming device of claim 29, wherein the award accelerator includes identical symbols.

53. The gaming device of claim 29, wherein the award increases by a random amount when the indicated combination of symbols in the set of activated symbol indicators is the award accelerator.

54. The gaming device of claim 29, wherein the award increases by a predetermined amount when the indicated combination of symbols in the set of activated symbol indicators is the award accelerator.

55. The gaming device of claim 29, wherein the award provided to the player in each activation is at least one of the awards selected from the group consisting of: an award in a previous activation, an award in the present activation, a multiplier in the previous activation and a multiplier in a present activation.

56. A gaming device comprising:
at least two sets of symbol indicators, each set having at least two symbol indicators with a plurality of symbols thereon;
an award accelerator including a combination of one of the symbols on one of the symbol indicators and one of the symbols on another of the symbol indicators of the same set; and
a processor which activates the symbol indicators in one of the sets for a plurality of activations, causes the symbol indicators in the activated set to indicate one of the symbols on each symbol indicator, in said set provides an award to a player in each activation, increases the award when the indicated combination of symbols on the symbol indicators in the activated set is the award accelerator.

57. The gaming device of claim 56, wherein the set to be activated is randomly determined.

58. The gaming device of claim 56, wherein the set to be activated is predetermined.

59. The gaming device of claim 56, which includes a selector associated with the sets of symbol indicators which enables the player to select one of the sets.

60. The gaming device of claim 56, which includes a plurality of selectors associated with the sets of symbol indicators which enable the player to select at least one of the sets.

61. The gaming device of claim 56, wherein the symbol indicators in a plurality of the sets are activated, and wherein one of the symbols on each symbol indicator in the plurality of activated sets is indicated in each activation.

62. The gaming device of claim 56, wherein the symbol indicators in all of the sets are activated, and wherein one of the symbols on each symbol indicator in the activated sets is indicated in each activation.

63. The gaming device of claim 56, which includes a terminator symbol associated with at least one symbol indicator, wherein the game terminates when the terminator symbol is indicated by the activated set of symbol indicators.

64. The gaming device of claim 56, which includes a terminator including a combination of one of the symbols on one of the symbol indicators and one of the symbols on another of the symbol indicators in each set of symbol indicators, wherein the terminator and the award accelerator include different combinations and wherein the activations terminate when the indicated combination in the activated set of symbol indicators is the terminator.

65. The gaming device of claim 64, which includes a probability of occurring associated with said terminator.

66. The gaming device of claim 65, wherein said probability of said terminator occurring changes in each activation of the symbol indicators.

67. The gaming device of claim 65, wherein said probability of said terminator occurring changes in a plurality of activations of the symbol indicators.

68. The gaming device of claim 65, wherein the processor randomly determines if said probability of said terminator occurring changes in each activation of the symbol indicators.

69. The gaming device of claim 65, wherein the processor randomly determines if said probability of said terminator occurring changes in a plurality of activations of the symbol indicators.

70. The gaming device of claim 56, which includes a terminator including a combination of one of the symbols on one of the symbol indicators and one of the symbols on another of the symbol indicators in the activated set in one of the activations, wherein the activations of the symbol indicators ends when said terminator symbol is indicated on the symbol indicators in the activated set in a subsequent activation.

71. The gaming device of claim 56, which includes a terminator including a sum of a combination of one of the symbols on one of the symbol indicators and one of the symbols on another of the symbol indicators in the activated set in one of the activations, wherein the activations of the symbol indicators ends when said terminator symbol is indicated on the symbol indicators in the activated set in a subsequent activation.

72. The gaming device of claim 56, which includes a terminator including a plurality of combinations of one of the symbols on one of the symbol indicators and one of the symbols on another of the symbol indicators in the activated set in one of the activations, wherein the activations of the symbol indicators ends when said terminator symbol is indicated on the symbol indicators in the activated set in a subsequent activation.

73. The gaming device of claim 56, which includes a plurality of award accelerators in at least one of the sets of symbol indicators.

74. The gaming device of claim 56, which includes a probability of being indicated associated with said award accelerator.

75. The gaming device of claim 74, wherein said probability of said award accelerator being indicated changes in each activation of the symbol indicators.

76. The gaming device of claim 74, wherein said probability of said award accelerator being indicated changes in a plurality of activations of the symbol indicators.

77. The gaming device of claim 74, wherein the processor randomly determines if said probability of said award accelerator being indicated change in each activation of the symbol indicators.

78. The gaming device of claim 74, wherein processor randomly determines if said probability of said award accelerator being indicated change in a plurality of activations of the symbol indicators.

79. The gaming device of claim 56, wherein the award accelerator includes identical symbols.

80. The gaming device of claim 56, wherein the award increases by a random amount when the indicated combination of symbols in the set of activated symbol indicators is the award accelerator.

81. The gaming device of claim 56, wherein the award increases by a predetermined amount when the indicated combination of symbols in the set of activated symbol indicators is the award accelerator.

82. The gaming device of claim 56, wherein the award provided to the player in each activation is at least one of the awards selected from the group consisting of: an award in a previous activation, an award in the present activation, a multiplier in a previous activation and a multiplier in the present activation.

83. A gaming device comprising:
at least one set of symbol indicators having a plurality of symbols thereon;
a terminator including a combination of one of the symbols on one of the symbol indicators and one of the symbols on another of the symbol indicators in each set of symbol indicators;
an award accelerator including a combination of one of the symbols on one of the symbol indicators and one of the symbols on another of the symbol indicators in each set of symbol indicators, wherein the award accelerator and the terminator include different combinations; and
a processor which randomly activates the symbol indicators for a plurality of activations, causes the symbol indicators to indicate one of the symbols on each symbol indicator in each activation, provides an award to a player in each activation, increases the award when the indicated combination of symbols on the symbol indicators is the award accelerator in any of the activations, terminates the activations when, the indicated combination is the terminator in any of the activations.

84. The gaming device of claim 83, which includes a plurality of terminators.

85. The gaming device of claim 83, which includes a probability of occurring associated with said terminator.

86. The gaming device of claim 85, wherein said probability of said terminator occurring changes in each activation of the symbol indicators.

87. The gaming device of claim 85, wherein said probability of said terminator occurring changes in a plurality of activations of the symbol indicators.

88. The gaming device of claim 85, wherein processor randomly determines if said probability of said terminator occurring changes in each activation of the symbol indicators.

89. The gaming device of claim 85, wherein processor randomly determines if said probability of said terminator occurring changes in a plurality of activations of the symbol indicators.

90. The gaming device of claim 83, wherein the terminator includes a combination of one of the symbols on one of the symbol indicators and one of the symbols on another of the symbol indicators in a first one of the activations, wherein the activations of the symbol indicators ends when said terminator is indicated on the symbol indicators in a subsequent activation to said first activation.

91. The gaming device of claim 83, wherein the terminator includes a sum of a combination of one of the symbols on one of the symbol indicators and one of the symbols on another of the symbol indicators in a first one of the activations, wherein the activations of the symbol indicators ends when said terminator is indicated on the symbol indicators in a subsequent activation.

92. The gaming device of claim 83, wherein the terminator includes a plurality combinations of one of the symbols on one of the symbol indicators and one of the symbols on another of the symbol indicators in one of the activations, wherein the activations of the symbol indicators ends when said terminator is indicated on the symbol indicators in a subsequent activation.

93. A gaming device comprising:
at least one set of number indicators having a plurality of numbers;
an award accelerator including a combination of one of the numbers on one of the number indicators and one of the numbers on another of the number indicators; and
a processor which randomly activates the number indicators for a plurality of activations, causes the number indicators to indicate one of the numbers on each number indicator in each activation, provides an award to a player in each activation, increases the award when the indicated combination of numbers on the number indicators is the award accelerator in any of the activations, and provides an accumulated award to the player after said plurality of activations.

94. The gaming device of claim 93, wherein the number indicators represent dice.

95. The gaming device of claim 93, which includes a terminating number including a combination of one of the numbers on one of the number indicators and one of the numbers on another of the number indicators, wherein the terminating number and the award accelerator include different combinations and wherein the activations terminate when the indicated combination is the terminating number in at least one of the sets of number indicators.

96. The gaming device of claim 93, which includes a plurality of terminating numbers including combinations of one of the numbers on one of the number indicators and one of the numbers on another of the number indicators in each set of number indicators, wherein the award accelerator and the terminator include different combinations of numbers and wherein the activations terminate when one of said terminating numbers is indicated on any of the number indicators in said sets.

97. The gaming device of claim 93, which includes a terminating number including a combination of one of the numbers on one of the number indicators and one of the numbers on another of the number indicators in one of the activations, wherein the activations of the symbol indicators ends when said terminating number is indicated on the number indicators in a subsequent activation.

98. The gaming device of claim 93, which includes a terminating number including a sum of a combination of one of the numbers on one of the number indicators and one of the numbers on another of the number indicators in one of the activations, wherein the activations of the symbol indicators ends when said terminator is indicated on the symbol indicators in a subsequent activation.

99. The gaming device of claim 93, which includes a terminating number including a plurality of combinations of one of the numbers on one of the number indicators and one of the numbers on another of the number indicators in one of the activations, wherein the activations of the symbol indicators ends when said terminator is indicated on the symbol indicators in a subsequent activation.

100. A gaming device comprising:
at least one pair of dice members having a plurality of symbols thereon;
an award accelerator including a combination of one of the symbols on one of the die members and one of the symbols on another of the die members in each pair of dice members; and
a processor which randomly activates the dice members for a plurality of activations, causes the pairs of dice members to indicate one of the symbols on each die member in each activation, provides an award to a player in each activation, and increases the award when the indicated combination of symbols on the dice member is the award accelerator in any of the activations.

101. The gaming device of claim 100, which includes a terminating number including a combination of one of the symbols on one of the die members and one of the symbols on another of the die members, wherein the terminating number and the award accelerator include different combinations and wherein the activations terminate when the combination of symbols on the dice members is the terminating number.

102. A gaming device comprising:
at least two pair of dice members having a plurality of symbols thereon;
an award accelerator including a combination of one of the symbols on one of the die members and one of the symbols on another of the die members of the same pair of dice members;
a selector for enabling a player to pick at least one of the pairs of dice members; and
a processor which randomly activates the dice members for a plurality of activations, co-acts with the selector to enable the player to pick at least one of the pairs of dice members, activates at least the selected pair of dice members, causes the dice members to indicate one of the symbols on each die member in each activation, provides an award to a player in each activation, and increases the award when the indicated combination of symbols on the dice members is the award accelerator in any of the activations.

103. The gaming device of claim 102, wherein the award is increased by a predetermined amount.

104. The gaming device of claim 102, wherein the award is increased by a random amount.

105. The gaming device of claim 102, wherein the symbols represent numbers.

106. The gaming device of claim 102, which includes a probability of being indicated associated with each number indicated on each die member in the pairs of dice members, wherein the probabilities are equal to the actual probabilities of the numbers being indicated on each die member in the pairs of dice members.

107. A gaming device comprising:
a set of symbol indicators including at least two symbol indicators having a plurality of symbols thereon;
an award accelerator including a combination of matching symbols on the symbol indicators; and
a processor which randomly activates the symbol indicators for a plurality of activations, causes the symbol indicators to indicate one of the symbols on each symbol indicator in each activation, provides an award to a player in each activation, and increases the award when the indicated combination of symbols on the symbol indicators is the award accelerator in any of the activations.

108. The gaming device of claim 107, wherein the matching symbols are matching numbers.

109. A gaming device comprising:
a cabinet;
a plurality of independently operated spaced apart mechanical die member holders individually attached to and extending externally from the top of the cabinet;
a display device for displaying a game; and
a processor mounted in the cabinet and adapted to control each mechanical die member holder, wherein the processor activates at least one of the die member holders in the game to indicate a symbol on the activated die member holder.

110. A method of operating a gaming device, said method comprising the steps of:
(a) determining a number of activations of symbol indicators;
(b) displaying at least one set of symbol indicators;
(c) activating the symbol indicators in at least one set;
(d) indicating one of the symbols on each symbol indicator in the activated set in each activation;
(e) providing an award to a player;
(f) increasing the award when an award accelerator including a combination of one of the symbols on each of the symbol indicators, is indicated by the symbol indicators in the activated set; and
(g) repeating steps (b) to (g) until there are no activations remaining.

111. The method of claim 110, which includes the step, of terminating the activations of the symbol indicators when a terminator symbol is indicated by at least one of the symbol indicators.

112. The method of claim 111, which includes the step of determining a combination of one of the symbols on one symbol indicator and one of the symbols on another symbol indicator to be a terminator symbol, wherein the terminator symbol and the award accelerator are different combinations of symbols.

113. The method of claim 111, which includes the step of determining a sum of a combination of one of the symbols on one symbol indicator and one of the symbols on another symbol indicator to be a terminator symbol in an activation wherein the terminator symbol and the award accelerator are different combinations of symbols.

114. The method of claim 111, which includes the step of determining a plurality of combinations of one of the symbols on one symbol indicator and one of the symbols on another symbol indicator to be a terminator symbol wherein the terminator symbol and the award accelerator are different combinations of symbols.

115. The gaming device of claim 110, which includes the step of terminating the activations of the symbol indicators when the terminator is indicated on the symbol indicators in at least one of the sets.

116. The method of claim 110, wherein the award is increased by a predetermined amount.

117. The method of claim 116, wherein the predetermined amount is based on a previous award.

118. The method of claim 110, wherein the award is increased by a random amount.

119. The method of claim 110, wherein the award accelerator includes a combination of identical symbols.

120. The method of claim 110, which includes the step of operating the gaming device through a data network.

121. The method of claim 120, wherein the data network is an internet.

122. A method of operating a gaming device, the method comprising the steps of:
(a) determining a number of activations of symbol indicators;
(b) displaying at least two sets of symbol indicators;
(c) activating at least one of the sets;
(d) indicating one of the symbols on each symbol indicator in each activated set;
(e) providing an award to a player;
(f) increasing the award when an award accelerator, which is a combination of one of the symbols on each of the symbol indicators, is indicated by the symbol indicators in each activated set; and
(g) repeating steps (b) to (g) until there are no activations remaining.

123. The method of claim 122, which includes the step of terminating the activations of the symbol indicators when a terminator symbol is indicated by at least one of the symbol indicators.

124. The method of claim 122, which includes the step of terminating the activations of the symbol indicators when a terminator symbol is indicated by at least one of the symbol indicators in at least one of the activated sets.

125. The method of claim 122, which includes the step of determining a combination of one of the symbols on one symbol indicator and one of the symbols on another symbol indicator to be a terminator, wherein the terminator and the award accelerator include different combinations of symbols.

126. The gaming device of claim 125, which includes the step of terminating the activations of the symbol indicators when the terminator is indicated on the symbol indicators in at least one of the activated sets.

127. The method of claim 122, which includes the step of operating the gaming device through a data network.

128. The method of claim 127, wherein the data network is an internet.

129. A method of operating a gaming device, the method comprising the steps of:
(a) determining a number of activations of symbol indicators;
(b) displaying at least one set of symbol indicators;
(c) activating the symbol indicators in at least one set;
(d) indicating one of the symbols on each symbol indicator in the activated set in each activation;
(e) providing an award to a player;
(f) increasing the award when an award accelerator, including matching symbols on the symbol indicators, is indicated by the symbol indicators in the activated set; and
(g) repeating steps (b) to (g) until there are no activations remaining.

130. The method of claim 129, which includes the step of operating the gaming device through a data network.

131. The method of claim 130, wherein the data network is an internet.
